(19) United States
(12) Patent Application Publication
(10) Pub. No.: US 2025/0153746 A1
(43) Pub. Date: May 15, 2025

(54) APPARATUS FOR SUPPORTING A SHEAVE ASSEMBLY ON A HOLDING DEVICE

(71) Applicant: Innova Patent GmbH, Wolfurt (AT)

(72) Inventors: Stefan SACCAVINI, Dornbirn (AT); Stefan LINDER, Hohenems (AT)

(73) Assignee: Innova Patent GmbH, Wolfurt (AT)

(21) Appl. No.: 18/940,082

(22) Filed: Nov. 7, 2024

(30) Foreign Application Priority Data
Nov. 15, 2023 (AT) A50926/2023

(51) Int. Cl. B61B 12/02

(52) U.S. Cl. CPC B61B 12/028

(57) ABSTRACT

An apparatus simplifying servicing and mounting of sheave assemblies, e.g., bearings, of cableways, to reduce the time required and to increase safety. The apparatus supports a sheave assembly, which includes a carrier unit, on a holding device and includes at least one holding recess on the holding device. The carrier unit includes a bearing part and a connecting recess provided in the bearing part. A connecting element is inserted through the connecting recess and through the at least one holding recess to pivotably support the carrier unit on the holding device via the connecting element. At least one securing element is arranged on the holding device to prevent relative movement between the securing element and the holding device radially to the axis of rotation. A securing recess is provided on the securing element and the bearing part of the carrier unit is at least partially arranged in the securing recess.

### CROSS-REFERENCE TO RELATED APPLICATION

This application claims priority under 35 U.S.C. § 119 (a) to Austria Application No. A50926/2023 filed Nov. 15, 2023, the disclosure of which is expressly incorporated by reference herein in its entirety.

### BACKGROUND

### 1. Field of the Invention

Embodiments relate to an apparatus for supporting a sheave assembly on a holding device. At least one holding recess is provided on the holding device and the sheave assembly comprises a carrier unit that includes a bearing part and a connecting recess provided in the bearing part. A connecting element is inserted through the connecting recess of the bearing part of the carrier unit and through the at least one holding recess of the holding device in order to support the carrier unit on the holding device via the connecting element so as to be pivotable about an axis of rotation. Embodiments also relate to a method for servicing and mounting a bearing of a sheave assembly on a holding device.

### 2. Discussion of Background Information

Cableways come in a wide variety of embodiments, mostly for the transportation of people and/or goods, e.g., as urban means of transportation or for the transportation of people in skiing regions, wherein cableway vehicles (e.g., with cabins, chairs, or other transportation containers) suspended from a cable are used for transportation. As a rule, cableways have at least two cableway stations, between which the cableway vehicles are moved via one or more cableway pylons by means of at least one cable.

The structure of a cableway pylon consists in principle of a foundation, the pylon itself, and a cross member, also referred to as a crosshead or crossbeam, at the top end of the pylon. Cableway pylons can be designed as a steel lattice structure or as a steel tube or sheet metal box structure. A plurality of sheaves, e.g., in the form of a so-called sheave assembly, are usually arranged on a cableway pylon or cross member in order to carry and guide the cable with the cableway vehicles. Connecting elements such as bolts are usually used to support the sheave assemblies on the cross member. In case of a plurality of sheave assemblies, the sheave assemblies can also be mounted on an additional carrier, which is then mounted on the cross member by means of bolts.

In cableways, the bolts must be subjected to a crack test periodically after 15 years (30.000 operating hours) and then every 10 years (20.000 operating hours). This involves considerable effort. In particular in the case of urban cableways, these crack tests must be carried out after just a few years (approx. 5 years) due to the very high number of operating hours per year. At the same time, there is the problem that due to their required availability, urban cableways have little time for servicing work to be carried out.

To service the bearing of a sheave assembly on a cableway pylon, the cable must be lifted and the sheave assembly must be removed in order to service the bearing, replace bolts or bushings and to be able to subject the bearing to a detailed inspection. To replace a bolt, the parts held by the bolt must be lowered from the cableway pylon after the bolt has been pulled out and then pulled up again for renewed mounting. For example, CH 713 297 A2 or WO 2016/058014 A1 disclose lifting the cable from the sheave assembly for servicing purposes. AT 249741 B describes an apparatus to facilitate the removal of the bolt.

The prior art discloses apparatuses and methods describing the servicing of sheave assemblies. In US 2016/0152244 A1 or EP 2 301 819 A2, for example, replacement or service vehicles, which are constructed similarly to a cableway vehicle, are used to lower a sheave assembly from a cableway pylon and lift it up for renewed mounting on the cableway pylon. Such lifting and lowering of the sheave assembly is time-consuming and costly.

### SUMMARY

Embodiments of the present invention to simplify the servicing and mounting of sheave assemblies, in particular the bearing, of cableways, to reduce the time required and to increase safety.

According to embodiments, an apparatus for supporting a sheave assembly on a holding device is provided. At least one securing element is arranged on the holding device, so that a relative movement between the securing element and the holding device radially to the axis of rotation is prevented by the arrangement. A securing recess is provided on the securing element and the bearing part of the carrier unit is at least partially arranged in the securing recess of the securing element. The securing element can be used to easily ensure that when the connecting element is removed from the bearing or inserted into the bearing, the carrier unit remains mounted on the holding device. This means that, for example, when servicing the bearing, the sheave assembly no longer needs to be lowered from the cableway pylon and then pulled up again, which increases safety for the cableway personnel on the one hand and also means that servicing takes less time. The securing element is particularly advantageous because it can also be retrofitted to existing cableways.

In a preferred embodiment, there is a gap in the arrangement between the securing recess of the securing element and the bearing part of the carrier unit, wherein the securing element comprises at least one adjustment element which, when the connecting element has been removed, is movable radially to the axis of rotation in order to arrange the bearing part of the carrier unit coaxially to the axis of rotation. This makes it easier to insert the connecting element when mounting the bearing. Moreover, as a result of the gap, when the connecting element is in the inserted state, wear of the securing element and/or the bearing part is reduced when the sheave assembly frequently pivots.

Preferably, the securing element is firmly connected to the holding device. Alternatively, the securing element is firmly connected to the bearing part of the carrier unit and the securing element is arranged on the holding device so as to be pivotable about the axis of rotation. In both embodiment variants, forces and torques that occur when the connecting element is removed can be easily transferred to the holding device.

In a preferred embodiment, the holding device has two side plates, in each of which a holding recess is provided and a receiving region for the bearing part of the carrier unit is formed between the side plates, wherein a securing element with a securing recess is arranged on each side plate, wherein a relative movement between the relevant securing element and the side plate of the holding device radially to the axis of rotation is prevented by the arrangement and wherein one axial end of the bearing part of the carrier unit is arranged at least partially in the securing recess of one of the securing elements. In comparison to a one-sided arrangement of the securing element, with the two-sided arrangement, forces and torques that occur when the connecting element is removed and because the bearing part of the carrier unit is arranged in the securing recess of the relevant securing element, can be distributed and transferred to the two side plates of the holding device.

In an advantageous method, the connecting element is removed from the connecting recess of the bearing part of the carrier unit and from the at least one holding recess of the holding device, whereby the carrier unit remains mounted on the holding device so as to be pivotable about the axis of rotation due to the arrangement of the bearing part of the carrier unit in the securing recess of the securing element, and in that when the previously removed connecting element is reinserted or when another connecting element is inserted through the connecting recess of the bearing part of the carrier unit and through the at least one holding recess of the holding device, the carrier unit is mounted on the holding device via the connecting element so as to be pivotable about the axis of rotation. The securing element allows the carrier unit to remain mounted on the holding device when the connecting element is removed from the bearing or inserted into the bearing. This means that, for example, when servicing the bearing, the sheave assembly no longer needs to be lowered from the cableway pylon and then pulled up again, which increases safety for the cableway personnel on the one hand and also means that servicing takes less time.

Preferably, there is a gap in the arrangement between the securing recess of the securing element and the bearing part of the carrier unit, and the adjustment element of the securing element is moved radially to the axis of rotation before the connecting element is inserted into the connecting recess in order to arrange the bearing part of the carrier unit coaxially to the axis of rotation. In particular, this makes it easier to insert the connecting element when mounting the bearing.

Other exemplary embodiments and advantages of the present invention may be ascertained by reviewing the present disclosure and the accompanying drawing.

### BRIEF DESCRIPTION OF THE DRAWINGS

The present invention is described in greater detail below with reference to FIGS. 1 to 5, which show schematic and non-limiting advantageous embodiments of the invention by way of example. In the figures:

FIG. 1 shows the basic structure of a sheave assembly and of a holding device;

FIG. 2 shows a sectional view of the apparatus according to the invention for supporting the sheave assembly on the holding device;

FIG. 3 shows a side view of a securing element of the apparatus according to the invention;

FIG. 4 shows a further embodiment of how a sheave assembly is supported on a holding device; and

FIG. 5 shows an exemplary method for servicing and mounting the bearing.

### DETAILED DESCRIPTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

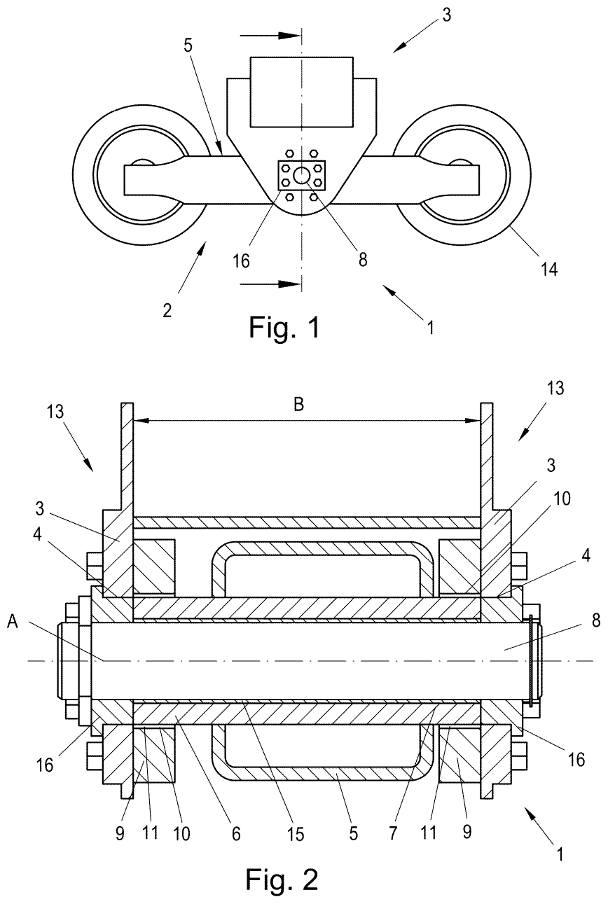

FIG. 1 shows the basic structure of a sheave assembly 2 and of a holding device 3. The holding device 3 can be designed as a cableway pylon (not shown) or can also be part of the cableway pylon, e.g., a cross member. The holding device 3 can be fastened to the cableway pylon for example with a screw connection. The sheave assembly 2 comprises a carrier unit 5. The carrier unit 5 is designed as a shaped tube in FIG. 2, although different embodiments and different cross sections are of course conceivable. A number of sheaves 14 are provided on the carrier unit 5, which are mounted on the carrier unit 5. The carrier unit 5 can be pivoted about an axis of rotation relative to the holding device 3.

A sheave assembly 2 is mounted on the holding device 3 with the apparatus 1 according to the invention. FIG. 2 shows a sectional view of the apparatus 1. At least one holding recess 4 (e.g., a bore) is provided on the holding device 3. The carrier unit 5 comprises a bearing part 6, wherein a connecting recess 7 is provided in the bearing part 6. As shown in FIG. 2, the bearing part 6 can be designed, for example, as a hollow cylinder extending through the cross section of the carrier unit 5.

Furthermore, a connecting element 8 is inserted through the connecting recess 7 of the bearing part 6 of the carrier unit 5 and through the at least one holding recess 4 of the holding device 3. The carrier unit 5 is thus mounted on the holding device 3 via the connecting element 8 so as to be pivotable about an axis of rotation A. The connecting element 8 can be designed, for example, as a bolt. The connecting element 8 can furthermore also comprise a bearing element 15, which is arranged between a peripheral surface of the connecting element 8 and the connecting recess 7 of the bearing part 6. The bearing element 15 can be designed as a hollow cylinder (e.g., a bushing, plain bearing bushing).

The connecting element 8 can furthermore have, for example, at least one circumferential groove on the peripheral surface, wherein a securing ring is provided in the circumferential groove, which serves to fix the connecting element 8 in the direction of the axis of rotation A.

At least one securing element 9 is arranged on the holding device 3, wherein the arrangement prevents a relative movement between the securing element 9 and the holding device 3 radially to the axis of rotation A, in particular in the direction of a gravitational force acting on the carrier unit 5. Two securing elements 9 are shown in the embodiment in FIG. 2. A securing recess 10 is provided on the securing element 9. The shape of the securing recess 10 preferably corresponds to the cross section of the bearing part 6. The bearing part 6 of the carrier unit 5 is at least partially arranged in the securing recess 10 of the securing element 9.

The securing element 9 is preferably firmly connected to the holding device 3 (e.g., with screws). Alternatively, the securing element 9 can also be firmly connected (e.g., welded) to the bearing part 6 of the carrier unit 5. As a result of being supported on the holding device 3, the sheave assembly 2 is arranged so as to be pivotable about the axis of rotation A. Therefore, the securing element 9 is also arranged on the holding device 3 so as to be pivotable about the axis of rotation A. In order for the securing element 9 to be pivotable, on the one hand, and to be fastened to the holding device 3 radially to the axis of rotation A, on the other hand, an arch-shaped groove (not shown), for example, may be provided in the holding device 3 through which screws are passed. The securing element 9 is fastened to the holding device 3 with the screws and the screws can move in the arcuate groove, whereby the securing element 9 is pivotable.

FIG. 2 shows a preferred embodiment of the holding device 3. The holding device 3 has two side plates 13. A holding recess 4 is provided in each of the side plates 13, and a receiving region B for the bearing part 6 of the carrier unit 5 is formed between the side plates 13. A securing element 9 with a securing recess 10 is arranged on each side plate 13. This arrangement prevents a relative movement between the relevant securing element 9 and the side plate 13 of the holding device 3 radially to the axis of rotation A. One axial end of the bearing part 6 of the carrier unit 5 is at least partially arranged in the securing recess 10 of one of the securing elements 9.

The apparatus 1 can further comprise at least one bearing cover 16, which is fastened to the holding device. Two bearing covers 16 are shown in the embodiment of the apparatus 1 in FIG. 2.

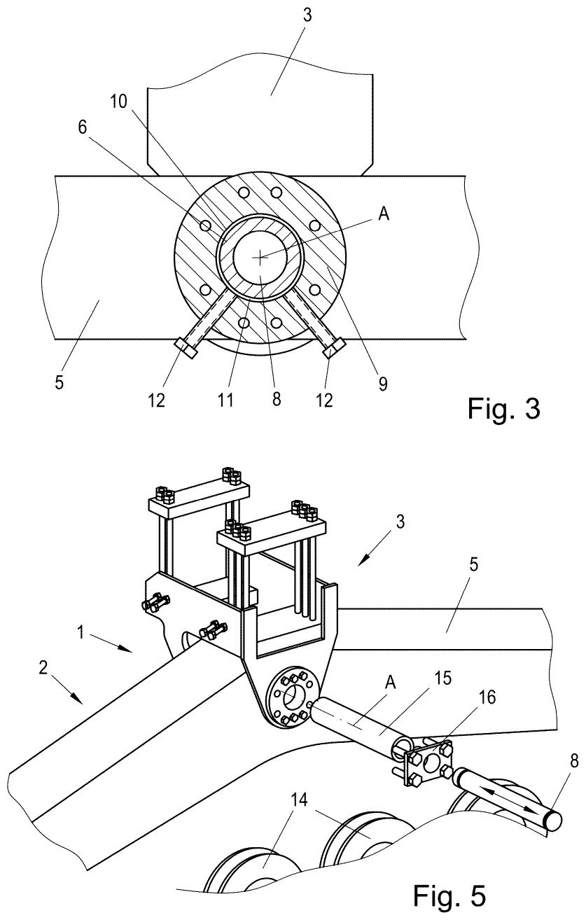

FIG. 3 shows a side view of the securing element 9 of the apparatus 1. The securing element 9 is shown to be ring-shaped. Of course, the securing element 9 can be designed to have other cross sections. There is a gap 11 (which is also shown in FIG. 2) in the arrangement between the securing recess 10 of the securing element 9 and the bearing part 6 of the carrier unit 5. The securing element 9 preferably comprises at least one adjustment element 12 which, when the connecting element 8 is removed, is movable radially to the axis of rotation A in order to arrange the bearing part 6 of the carrier unit 5 coaxially to the axis of rotation A. FIG. 3 shows two adjustment elements 12, which are designed, for example, as screws. By screwing the screws into the securing element 9, they come into contact with the bearing part 6, causing the bearing part 6 to move towards the axis of rotation A.

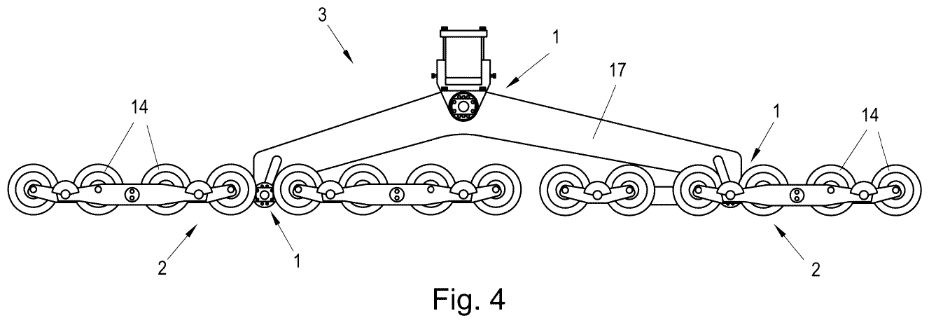

FIG. 4 shows another embodiment of how a sheave assembly 2 is supported on a holding device 3. The holding device 3 comprises an additional carrier 17, on which a sheave assembly 2 with an apparatus 1 is mounted in each case. The sheave assemblies 2 are in turn mounted on the holding device 3 via the carrier 17 with a further apparatus 1.

FIG. 5 shows an exemplary method for servicing and mounting the bearing of the sheave assembly 2 on a holding device 3 with the apparatus 1. Here, the connecting element 8 is removed from the connecting recess 7 of the bearing part 6 of the carrier unit 5 and from at least one holding recess 4 of the holding device 3 (indicated by an arrow). The bearing cover 16 and the bearing element 15, if present, are also removed. This allows the bearing to be inspected, e.g., for wear of the connecting element 8 or bearing element 15.

When the connecting element 8 is removed, the carrier unit 5 remains mounted on the holding device 3 so as to be pivotable about the axis of rotation A due to the arrangement of the bearing part 6 of the carrier unit 5 in the securing recess 10 of the securing element 9. When the previously removed connecting element 8 is reinserted or when another connecting element 8 is inserted (e.g., in case the connecting element 8 broke) through the connecting recess 7 of the bearing part 6 of the carrier unit 5 and through the at least one holding recess 4 of the holding device 3, the carrier unit 5 is mounted on the holding device 3 via the connecting element 8 so as to be pivotable about the axis of rotation A.

To reinsert the removed connecting element 8 or to insert a different connecting element 8, the bearing part 6 is preferably moved with the adjustment element 12 of the securing element 9 radially to the axis of rotation A in order to arrange the bearing part 6 of the carrier unit 5 coaxially to the axis of rotation A. For this purpose, the screws as adjustment elements 12 can be screwed into the securing element 9, whereby they come into contact with the bearing part 6 and move the bearing part 6 towards the axis of rotation A.

In this context, the term “servicing” describes various activities that can be carried out by the cableway personnel when the connecting element 8 is removed from the bearing. For example, the support of the sheave assembly 2 on the holding device 3 can be inspected by the cableway personnel, the connecting element 8 can be checked for cracks, the connecting element 8 and/or the bearing element 15 can be replaced, in the case of wear, etc. The apparatus 1 according to the invention can ensure that as a result the sheave assembly 2 remains mounted on the holding device 3.

In this context, the term “mounting” also describes the initial mounting of the apparatus 1, with which the apparatus 1 is assembled by inserting the connecting element 8.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. An apparatus for supporting a sheave assembly on a holding device, comprising:
at least one holding recess on the holding device;
the sheave assembly comprises a carrier unit that includes a bearing part and a connecting recess in the bearing part;
a connecting element is inserted through the connecting recess of the bearing part of the carrier unit and through the at least one holding recess of the holding device in order to support the carrier unit on the holding device via the connecting element so as to be pivotable about an axis of rotation;
at least one securing element is arranged on the holding device, so that relative movement between the securing element and the holding device radially to the axis of rotation is prevented by the arrangement;
a securing recess is provided on the securing element; and
the bearing part of the carrier unit is at least partially arranged in the securing recess of the securing element.

2. The apparatus according to claim 1, wherein a gap is formed in the arrangement between the securing recess of the securing element and the bearing part of the carrier unit,
wherein the securing element comprises at least one adjustment element which, when the connecting element is removed, is movable radially to the axis of rotation in order to arrange the bearing part of the carrier unit coaxially to the axis of rotation.

3. The apparatus according to claim 1, wherein the securing element is firmly connected to the holding device.

4. The apparatus according to claim 1, wherein the securing element is firmly connected to the bearing part of the carrier unit and the securing element is arranged on the holding device so as to be pivotable about the axis of rotation.

5. The apparatus according to claim 1, wherein the holding device has two side plates, in each of which the holding recess is provided, and a receiving region for the bearing part of the carrier unit is formed between the side plates,
wherein the securing element with the securing recess is arranged on each side plate,
wherein the relative movement between the relevant securing element and the side plate of the holding device radially to the axis of rotation is prevented by the arrangement, and
wherein one axial end each of the bearing part of the carrier unit is arranged at least partially in the securing recess of one of the securing elements.

6. A method for servicing and mounting a bearing of a sheave assembly on a holding device with an apparatus according to claim 1, wherein the connecting element is removed from the connecting recess of the bearing part of the carrier unit and from the at least one holding recess of the holding device, whereby the carrier unit remains mounted on the holding device due to the arrangement of the bearing part of the carrier unit in the securing recess of the securing element, the method comprising:
via one of: when the previously removed connecting element is reinserted through the connecting recess of the bearing part of the carrier unit and through the at least one holding recess of the holding device or when a different connecting element is inserted through the connecting recess of the bearing part of the carrier unit and through the at least one holding recess of the holding device, mounting the carrier unit on the holding device via the connecting element so as to be pivotable about the axis of rotation.

7. The method according to claim 6, wherein a gap formed in the arrangement between the securing recess of the securing element and the bearing part of the carrier unit and the method further comprises, before the connecting element is inserted into the connecting recess, moving the adjustment element of the securing element radially to the axis of rotation in order to arrange the bearing part of the carrier unit coaxially to the axis of rotation.
